(19) United States
(12) Patent Application Publication
(10) Pub. No.: US 2003/0228525 A1
(43) Pub. Date: Dec. 11, 2003

(54) Lead-acid battery having an organic polymer additive and process thereof

(76) Inventors: Akiya Kozawa, Aichi-Ken (JP); Hirofumi Harada, Ichinomiyashi (JP); Gijun Yokol, Komaki (JP)

Correspondence Address: Cornelius O'Brien, 30 Rural DY, New Canaan, CT, 06840, US

(21) Appl. No.: 10/439,258

(22) Filed: May 15, 2003

(30) Foreign Application Priority Data
May 16, 2002 (JP) 2002-14177

(51) Int. Cl. H01M 10/08; H01M 10/44

(52) U.S. Cl. 429/347; 429/204; 429/205; 429/50

(57) ABSTRACT

A process for prolonging the life of a lead-acid battery by adding an organic polymer and ultra fine lignin to its electrolyte and then charging the battery and the battery so produced.

### FIELD OF THE INVENTION

A lead acid battery having an electrolyte containing an additive of a polyvinyl alcohol and/or organic polymer with an ultra fine lignin that will permit the lead-acid battery to be recharged to prolong the useful life of the battery and a process thereof.

### BACKGROUND OF THE INVENTION

Lead-acid batteries are being widely used for cars, trucks, buses, forklifts, golf carts and the like. The lead-acid batteries can also be used for solar power generated electricity storage and in hybrid cars in the near future. The total use of this type of battery could soon be extremely large and could pose an environment problem. Therefore, it is desirable to recycle these batteries and extend their service life. However, the recharging of these batteries is costly and not completely effective.

It is an important object of the invention to prolong the life of lead-acid batteries by providing an additive to the electrolyte that will permit the batteries to be recharged for many additional years of service.

It is another object of the invention to provide a novel additive to the electrolyte of a used battery that will permit the battery to be recharged to effectively enhance its new power properties.

It is another object of the invention to provide a process for recharging a used lead-acid battery to prolong its use life by adding a novel additive to the electrolyte before or after the recharging process.

### SUMMARY OF THE INVENTION

In one embodiment of the invention, the claim relates to an electrochemical lead-acid battery having an electrolyte containing an additive of an organic polymer and an ultra fine lignin, preferably an additional additive or agent for antiforming and said additional additive selected from the group consisting of indium, tin, lead sulfate, barium sulfate and mixtures thereof. For most applications, a 5% aqueous polyvinyl alcohol solution should be added in an amount between about 1 cc and about 10 cc, per 12-volt 50-Ampere battery, preferably between 2 cc and about 6 cc, and more preferably, between 3 cc and about 5 cc. Preferably, the polymer could be used in a powder form or an aqueous solution having an organic polymer of between about 0.1% and about 13%, preferably between about 2% and about 5% and more preferably about 3.5% in water. An addition of an antiforming additive could be used in an amount preferably between about 0.01% and about 0.1% per 12-volt 50-Ampere battery, more preferably about 0.02 and about 0.05.

Polyvinyl alcohol, acrylic polymer and ultra fine lignin do not effectively dissolve in water or in the battery using an acid electrolyte composed of H₂SO₄ (5M H₂SO₄, 28% by volume of H₂SO₄). In such cases, in order to quickly produce a soluble polymer powder, 6% to 12% NaSO₄ would be mixed, and this procedure would be for most applications. Suitably antiforming additives are the compounds of indium, such as indium oxide and indium sulfate, or tin compounds such as tin sulfate, tin oxide and divalent tin; barium sulfate and lead sulfate. Lignin is a complex substance known to be non-polysaccharides. The constitution of lignin has not been clarified but is probably a polymerized coniferyl alcohol.

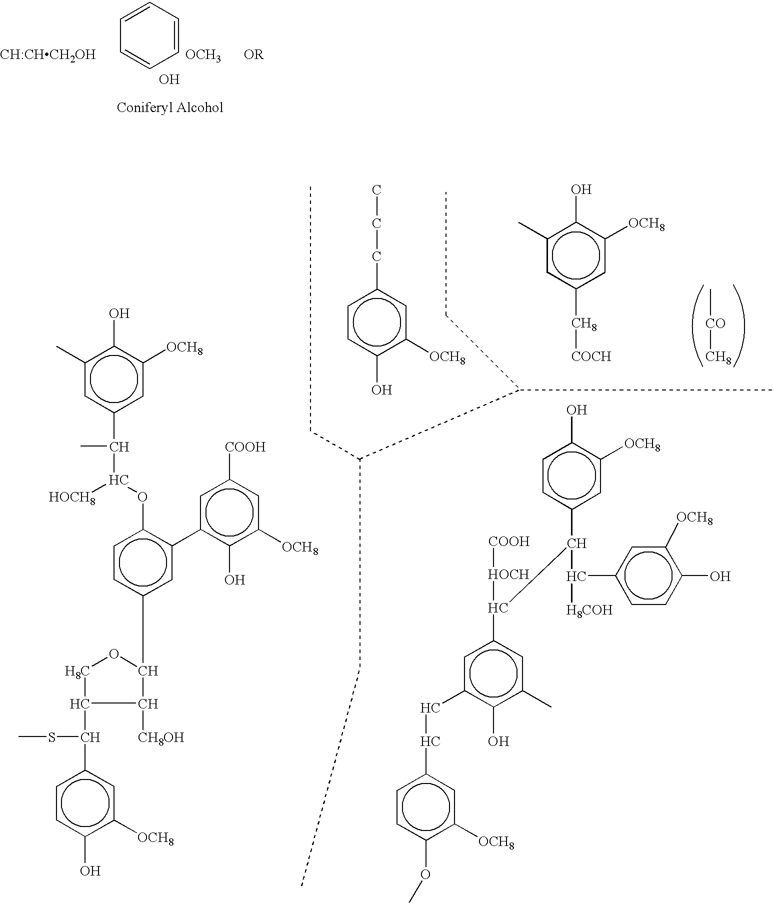

The fine lignin is preferably sized between about 0.01 and 0.8 microns and contains about 0.01 and about 3 wt percent of the electrolyte. Preferably, the size of the lignin is between 0.1 and 0.6 microns.

Another embodiment of the invention is a process of charging a lead acid battery containing an electrolyte such as H₂SO₄, comprising the following steps: 1) adding to the electrolyte of the battery having a specific gravity less than 1.2, an additive of a polyvinyl alcohol and/or an acrylic polymer and an ultra fine lignin; and 2) charging the battery at a high current rate at least once to increase the specific gravity of the electrolyte by at least 3% or to greater than 1.22, preferably greater than between about 1.26 and about 1.28. Preferably, an antiforming agent could be used, such as indium, tin, lead sulfate, barium sulfate and mixtures thereof. For most applications the 5% polyvinyl alcohol in water should be added in an amount between about 1 cc and about 10 cc per cell per 12-volt 50-Ampere battery, preferably between 3 cc and 7 cc and more preferably about 5 cc. Polyvinyl alcohol polymer could be used in a powder form or an aqueous solution having an organic polymer of between about 0.1% and about 13%, preferably between about 2% and about 5% and most preferably about 3% per 12-volt 50-Ampere battery. If required, the antiforming agent for the process could be added in an amount between about 0.01 gram and about 0.1 gram per 12-volt 50-Ampere battery, more preferably about 0.05 and about 0.08 gram.

Another embodiment of the invention is to add the novel additives to a lead-acid battery before it is charged so that charging of the battery can occur during its use. This would entail adding the novel additives to the electrolyte along with its other conventional components before the initial charging of the battery. In most applications, the lignin and, if desired, an antiforming agent could also be added to the electrolyte before the initial charging. Preferably, the high rate charging and discharging cycle can be repeated more than once.

### BRIEF DESCRIPTION OF THE DRAWINGS

FIG. 1 is a plot of a curve of the specific gravity of the electrolyte of a battery and its voltage.

FIG. 2 is a plot of a curve of the deterioration of a battery showing the capacity (% AH) versus time.

FIG. 3 shows plots of the time potential curves of a lead electrode. FIG. 4 shows plots of the volts versus discharge current for a 12-volt 40-Ampere battery (28 Amperes at 5-hour rate).

FIG. 4

| | |
|---|---|
| Curve a: | no Sb addition (new battery) |
| Curve b: | Sb of 102.2 ppm was added to the |
| | electrolyte and charge at 3 Ampere |
| | for four minutes |
| Curve c: | After a high current discharge, 60- |
| | Ampere discharge to 9 Volts, 16 |
| | minutes continuous discharge |
| Curve d: | After charge at 1.5˜2.0 Ampere and a |
| | large current discharge (60 Ampere, |
| | 15 minutes discharge), twice |

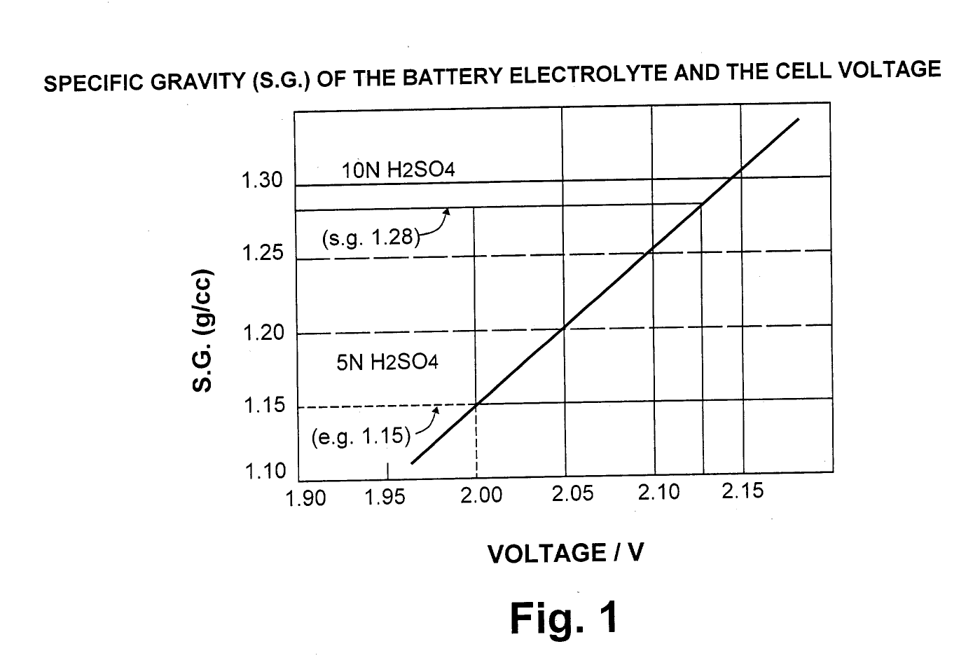

For 3-10 ton vehicles, 24 volt lead-acid batteries (such as 2 12-volt batteries connected in series) have been used and such batteries would have between 80-155 Ah. The average life of these batteries is typically three years. FIG. 1 shows the voltage and the specific gravity of a normal lead-acid battery using an electrolyte of H₂SO₄ . When the battery is fully charged, the general value of the specific gravity is about 1.28 g/cc (10N H₂SO₄) and decreases to generally about 1.15 (5N H₂SO₄) when effectively discharged. The cell reaction of the negative electrode is:

$${PbSO}_{4} ( active form ) + 2 H {{↔}^{charged}}_{ discharged } {PbSO}_{4} ( active form ) + {H}_{2} {SO}_{4}$$

The porous active form of PbSO₄ is converted to fine active metallic lead and H₂SO₄ is generated. Therefore, after the high rate charging is complete, the H₂SO₄ concentration increases as does the specific gravity to 1.28 or higher. In the deteriorated lead-acid battery, the active PbSO₄ powder is converted to crystalline lead sulfate, which is difficult to charge back to the fine active lead using a normal charge under normal charging conditions. The additive of this invention can effectively allow the conversion of the crystalline PbSO₄ to the porous active form.

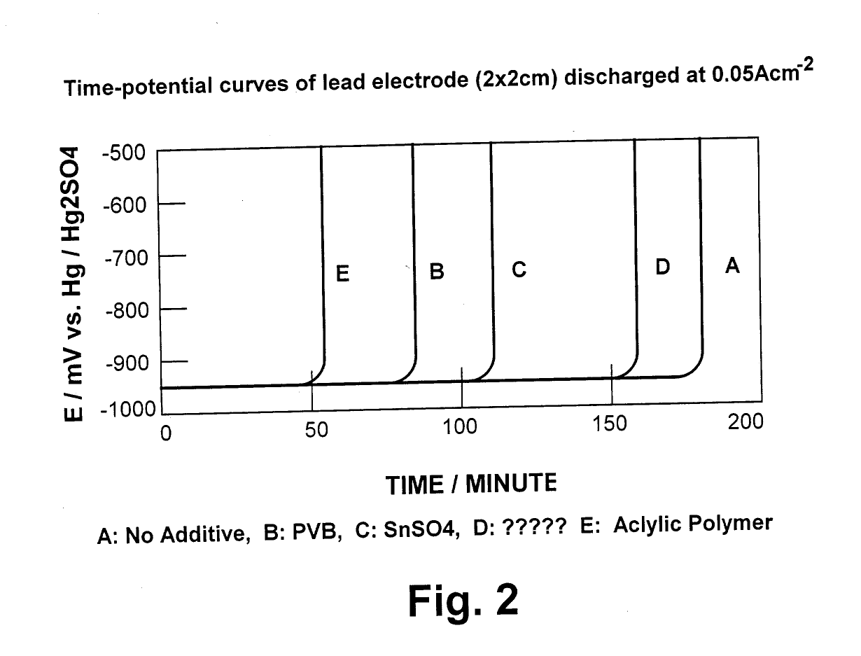

The organic polymers of this invention are absorbed onto the electrode and slow down the PbSO₄ formation process (FIG. 2). When a flat lead plate is anodized (discharged) at a constant current (0.05 mA/cm²), the produced Pb²⁺ (Pb⁰→Pb²⁺) combines with SO₄²⁻ (sulfate ion) and produces a PbSO₄ deposit on the electrode surface when the organic polymer is added to the electrolyte. The organic polymer of SnSO₄, lignin, etc., is adsorbed on the electrode and influences the PbSO₄ deposition as shown in FIG. 2. These results shown in FIG. 2 indicate that the additive material has a clear effect on the electrode reaction. The reaction consists of two steps (1 and 2):

(1) Pb₀→Pb²⁺+e (charge transfer)

(2) Pb²⁺+SO₄²⁻→PbSO₄ (precipitation)

It is not known which step (1 or 2) has a more significant effect to produce the overall beneficial effect. The beneficial effect observed is the increase in the specific gravity or removal of sulfation (removal of crystalline PbSO₄ deposit) from the negative electrode or some from the positive electrode. The beneficial effect is confirmed from the increase in the specific gravity of the electrolyte. The specific gravity increase is proportional to the increase in the battery's AH (Operation time).

The high rate discharge current is a very important factor for producing fine (high surface area) lead sulfate. When the battery is discharged and left uncharged, the produced PbSO₄ will recrystallize to produce large crystalline PbSO₄, resulting in a dead battery. This type of deterioration is called “sulfation”. To reactivate the sulfated dead battery, a low current-long time (slow) charging is known to be effective, since the dissolution rate of PbSO₄ is very slow when the crystallite size is large. The dissolved Pb²⁺+SO₄²⁻² deposits as metal. The polymer additive is very effective for producing a high surface area (active) metallic lead. Therefore, the polymer additive is effective under a charging for battery regeneration (recovery from sulfation).

A high current discharge (1C or greater, 2C-3C or higher for 4 minutes or more is preferred) produces a high surface area PbSO₄. This is the first step in making an active battery. When our additives are added to the acid electrolyte, the fine (high surface area) PbSO₄ is converted into fine metallic lead (active negative electrode). Repeated high rate charging-discharging is very important to make the deteriorated battery active in the presence of the organic polymer in the electrolyte. To prolong the battery life, it is recommended to keep the battery always in the active state by adding the novel additives to the electrolyte from the beginning of battery use. The effect of the organic polymer and ultra fine lignin additives upon discharge produces on the surface of a lead electrode a fine PbSO₄ that is converted to fine metallic lead.

Old battery electrolytes usually have some dissolved impurities (usually antimony dissolved from grid alloy of the positive plate). Antimony addition markedly reduces the hydrogen overvoltage for the negative electrode and effectively there is no effect on the positive electrode. When a tin or indium compound is added, for example, 100-300 ppm to the sulfuric acid solution, the curve of the negative electrode vs. a CD reference electrode shifts to a more negative value. This means that the hydrogen overpotential is increased. The tin or indium is probably deposited on the electrode and covers the antimony deposited hydrogen evolution sites. These metallic additives, lead sulfate and barium sulfate, are preferably used because they are effective for quick battery improvement.

Eight discarded 6-volt 150 AH lead-acid batteries were examined and the results are shown in Table 1.

TABLE 1

| | | | Specific |
|---|---|---|---|
| Battery No. | Capacity | Volts | Gravity |
| 1 | 150 | 5, 9 | LG |
| 2 | 150 | 6, 1 | 1140 |
| 3 | 150 | 5, 7 | 1200 |
| 4 | 150 | 5, 8 | 1180 |
| 5 | 150 | 5, 5 | 1160 |
| 6 | 150 | 4, 9 | 1200 |
| 7 | 150 | 5, 0 | 1120 |
| 8 | 150 | 5, 9 | LG |

For the batteries of Table 1, 15 cc of the 5% organic polymer solution (activator) and deionized water were added to the indicated water level in each battery. The eight batteries were then charged at 8.0 Amperes for 24 hours. This was followed by charging at 3.0 Amperes for four days for reactivation. This long low current charge is to remove any sulfation in order to reactivate the negative electrode. After the 4-day low current (3 Amperes) continuous charge, the specific gravity of the electrolyte and the voltage had increased, as shown in Table 2. The specific gravity values and the battery voltages had recovered to almost their normal fully-charged levels. These regenerated batteries were tested using a 200-Ampere 5-sec. test. These results are shown in Table 3.

TABLE 2
Specific Gravity and Voltage of the
Activation Operation at 3 Amperes
For 4 Days.

| Battery No. | Specific Gravity | Volts |
|---|---|---|
| 1 | 1250 | 6, 30 |
| 2 | 1250 | 6, 24 |
| 3 | 1250 | 6, 24 |
| 4 | 1250 | 6, 32 |
| 5 | 1250 | 6, 22 |
| 6 | 1250 | 6, 31 |
| 7 | 1250 | 6, 15 |
| 8 | 1250 | 6, 17 |

TABLE 3
200 Amp-5 Sec. Test Results of
Regenerated Batteries.

| | | CCV (5 sec | |
|---|---|---|---|
| Battery No. | OCV | after %00 amp.) | |
| 1 | 6.27 | 4.87 | OK |
| 2 | 6.22 | 3.97 | — |
| 3 | 6.22 | 4.35 | — |
| 4 | 6.29 | 4.66 | OK |
| 5 | 6.19 | 4.84 | OK |
| 6 | 6.28 | 4.75 | OK |
| 7 | 6.12 | 4.60 | OK |
| 8 | 6.15 | 4.56 | OK |

The lead-acid batteries for use in forklifts are rated at 350 to 650 AH and 48 volts. The typical life of these batteries is 4 to 5 years.

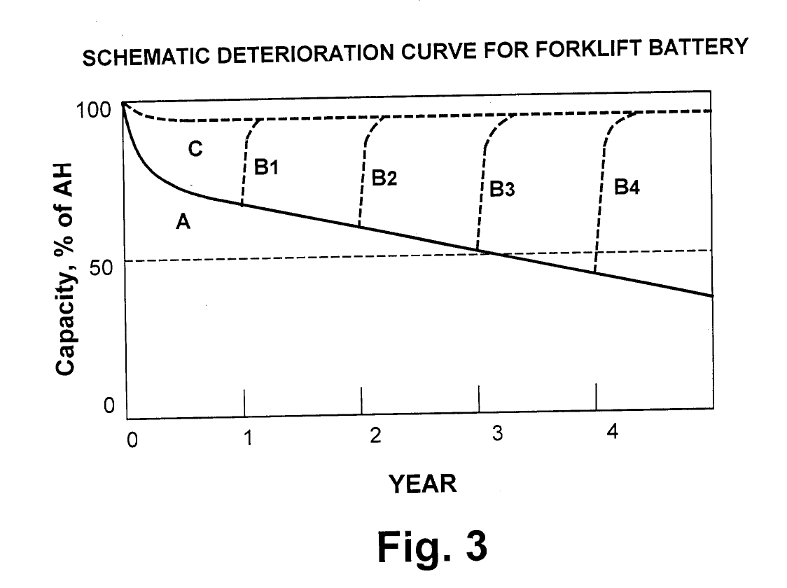

As shown in FIG. 3, these batteries gradually deteriorate. For the first year, the deterioration is 15% or more, and then for the second year and beyond, the deterioration is 7-10% per year. When the polymer (15 cc of the 5% polymer solution) is added to these types of batteries, the battery Ampere-hours remains almost constant at 95-96% of the original rating. As shown in FIG. 3, curve A shows the deterioration of the battery when no polymer additive is used. The AH capacity of the battery decreases to less than 40% after four to five years. Curve B shows the deterioration of the battery with the polymer additive in the electrolyte. Curve C shows the deterioration of a new battery when the polymer additive is added to the electrolyte once a year. This shows that regardless of the age of the battery, the partially deteriorated battery will recover to 85% to 90% of its original AH. Some polymers may effect the water, and in some applications, water may be added to the battery. A combined battery activation method of a high or large current discharge and an organic polymer and ultra fine lignin additions are far more effective compared to the polymer addition only, or only a large current discharge. To support this conclusion, experimental tests were performed and electron microscope pictures of the discharge products (PbSO₄) were studied. The results showed that the discharged product became finer when the discharge current became higher. A high current rate is at least 1.0 C, preferably 1.5 C to 2 C and higher for at least 5 minutes. A large current discharge can be accomplished by shorting the battery through a resistance for 1 to 10 minutes and if its resistance is cooled (as in water), then the time of discharge can be increased to 20 minutes. Once finer lead sulfate is produced, the battery's active material remains fine regardless of the subsequent operation. A large current discharge is common for engine starting for 2 to 5 seconds. The current is 1 C to 2 C for most engine starting. For a 40-Ampere battery, the engine starting requires 50 to 75 Amperes for 2 to 5 seconds. Preferably, high current discharge is 1 to 20 minutes of continuous discharge at 1 C to 3 C rate, by which the 10 to 60% of the active material is converted to fine PbSO₄ from metallic lead. The fine PbSO₄ (lead sulfate) becomes a nucleus for the subsequent charge-discharge operation and the active material remains D active. Also, the toxic antimony effect disappears upon the large current discharge. Two to six percent of antimony is in the grid alloy (Pb—Sb)of the positive electrode. The antimony (Sb) dissolves slowly into the sulfuric acid electrolyte (5M H₂SO₄, 28% H₂SO₄). The dissolved antimony ion (SB³⁺ or Sb⁵⁺) moves to the negative plate and deposits there. The antimony deposits become hydrogen gas evolution sites, since the hydrogen evolution takes place much more easily at the Sb surface compared to the Pb surface. One of the main causes of lead acid battery deterioration is due to the antimony effect. Since the hydrogen evolution reaction (1),and charge reaction (2) of the negative electrode are competitive reactions during the charge process:

(1) H++e−−H₂↑

(2) PbSO₄→Pb²⁺+e−ΔPb^{o} (metallic)

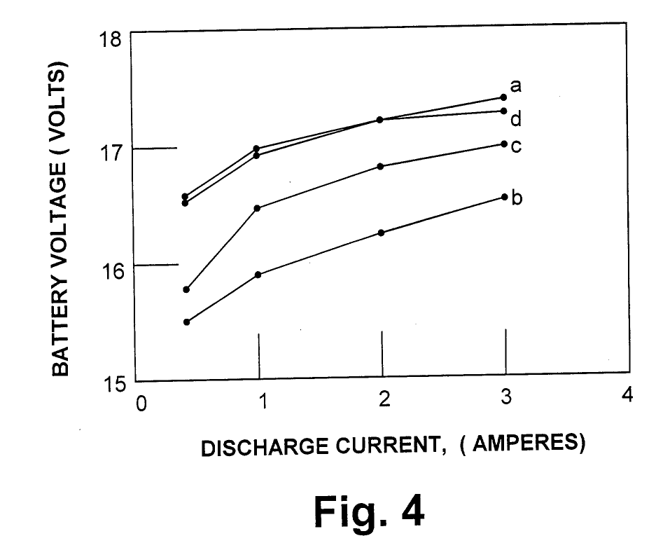

The reaction (1) takes place when the charge voltage is 16 to 17 volts at pure lead electrode and takes place at around 14 to 15 volts at Sb deposited-Pb electrode. Therefore, when the solution has Sb, water electrolysis significantly takes place so that all the charge current is not utilized for the charge reaction (2). This means in the presence of Sb, the charge is not efficient and uncharged PbSO₄ remains in the electrode and becomes so-called sulfation (formation of crystalline PbSO₄) and the battery starts to deteriorate. FIG. 4 shows the large current discharge effect. The toxic effect of Sb (lowers the battery voltage upon charge) is shown by curve b. Namely, addition of Sb (102.2 ppm in the electrolyte) makes the current voltage curve move from (a) to (b). After a large current discharge, the curve shifts from (b) to (c) and further shifts from (c) to (d) after two times of discharge-charge operation (the discharge being a large current discharge, 60 Amp-15 min.). The beneficial action of lignin is the high hydrogen overpotential compared to carbon and lignin is easy to grind to fine particles compared to carbon. A 5% PVA mixture aqueous solution with and without varying sizes of lignin particles was added to a 5 cc/cell deteriorated lead acid battery. The battery was repeatedly charged-discharged three times. The results of these tests are shown in Table 4.

TABLE 4

| | | Specific Gravity | |
|---|---|---|---|
| | Average Size | Before | After |
| | of Lignin | Charge | Charge |
| Sample 1 | 0.3 mm | 1.28 | 1.32 |
| Sample 2 | 2.0 mm | 1.24 | 1.30 |
| Sample 3 | no lignin | 1.19 | 1.26 |

TABLE 5

| | Average Size | 150 Ampere 5-Second Test |
|---|---|---|
| | of Lignin | Voltage at 5 Seconds |
| Sample 1 | 0.3 mm | 11.4-11.5 Volt |
| Sample 2 | 2.0 mm | 11.1-11.2 Volt |
| Sample 3 | no lignin | 10.8-11.0 Volt |

The results demonstrate that the finer the lignin size, the battery activation effect is much better. Ultra fine particles (0.01-0.8 micron) and PbSO₄ and/or BaSO₄ can be added to the battery and deposit on the negative electrode. The deposit of BaSO₄ and/or PbSO₄ can act as a nucleus of PbSO₄ formation; therefore the battery electrode can be easily activated.

It is to be understood that modifications and changes to the preferred embodiments of the invention herein can be made without departing from the spirit and scope of the invention.

What is claimed

1. An electrochemical lead-acid battery having an electrolyte containing an organic polymer and an ultra fine lignin having a particle size between about 0.01 and about 0.8 micron.

2. The electrochemical lead-acid battery of claim 1 wherein the ultra fine lignin has a particle size between about 0.1 and about 0.6 micron.

3. The electrochemical lead-acid battery of claim 1 wherein the organic polymer is at least one organic polymer selected from the group comprising polycrylic acid or its copolymers, polyvinyl alcohol and ethylene glycol.

4. The electrochemical lead-acid battery of claim 1 wherein the electrolyte contains at least one additional additive selected from the group of materials consisting essentially of indium, tin, lead sulfate, barium sulfate and mixtures thereof.

5. The electrochemical lead-acid battery of claim 4 wherein the electrolytes contains an antimony as an impurity.

6. The electrochemical lead-acid battery of claim 1 wherein the polymer is present in an aqueous solution wherein the polymer is between about 0.1% and 13% in water.

7. The electrochemical lead-acid battery of claim 6 wherein the organic polymer is polyvinyl alcohol.

8. The electrochemical lead-acid battery of claim 2 wherein the electrolyte contains at least one additional additive selected from the group of materials consisting essentially of indium, tin, lead sulfate, barium sulfate, and mixtures thereof.

9. The electrochemical lead-acid battery having an electrolyte containing at least one organic polymer selected from the group consisting of polycrylic acid or its copolymers, polyvinyl alcohol and ethylene glycol and wherein the polymer is present in an about between about o,1% and about 13% in water.

10. The electrochemical lead-acid battery of claim 9 wherein the electrolyte contains at least one additional additive selected from the group of materials consisting essentially of indium, tin, lead sulfate, barium sulfate and mixtures thereof.

11. The electrochemical lead-acid battery of claim 10 wherein said additional additive is present in an amount between about 0.01% and about 0.1% per 12-Volt 50-Ampere battery.

12. The electrochemical lead-acid battery of claim 10 wherein the additional additive is lead sulfate or barium sulfate.

13. The electrochemical lead-acid battery of claim 10 wherein the additional additive is indium.

14. A process of charging a lead-acid battery containing an electrolyte and active components comprising the steps:
a) adding to the electrolyte of the battery at least one organic polymer; and
b) changing the battery at a high current rate of at least 1 C. for at least five minutes.

15. The process of claim 14 wherein step a) at least one additional additive selected from the group of materials consisting essentially of indium, tin, lead sulfate, barium sulfate and mixtures thereof is added to the electrolyte.

16. The process of claim 14 wherein the organic polymer is a selected from the group consisting essentially of polycrylic acid or its copolymers, polyvinyl alcohol and ethylene glycol.

17. The process of claim 14 wherein the battery in step b) is charged at least once at a high current rate of at least 1.5 C. for at least five minutes.

18. The process of claim 14 wherein an ultra fine lignin is added to the electrolyte of step a).

19. The process of claim 14 wherein the charging is repeated more than twice providing a plurality of cycles.

20. The process of claim 19 wherein the additives are added to the electrolyte along with active components before the initial charging of the battery.
